(19) United States
(12) Patent Application Publication
(10) Pub. No.: US 2006/0293782 A1
(43) Pub. Date: Dec. 28, 2006

(54) Method for regulating the flow of product along an accumulation conveyor

(76) Inventor: Steven D. Rees, Bothell, WA (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/167,789

(22) Filed: Jun. 27, 2005

(51) Int. Cl. G06F 7/00

(52) U.S. Cl. 700/230

(57) ABSTRACT

A method of controlling the transport of product along an accumulation conveyor is provided. The accumulation conveyor has a plurality of zones. Each zone is independently driven and has a status corresponding to the presence of product thereon. The method includes the steps of generating a first data table containing instructions for transporting the product between a first pair of zones of the accumulation conveyor and monitoring the status of the plurality of zones. A first zone is driven in response to the status of the plurality of zones in accordance with the instructions.

### FIELD OF THE INVENTION

This invention relates generally to conveyors, and in particular, to a method for customizing a basic control algorithm for regulating the flow of product along an accumulation conveyor.

### BACKGROUND AND SUMMARY OF THE INVENTION

Accumulation conveyors are divided or segmented into a plurality of discreet control zones that control the transport of the product along the conveyor. Operation of the zones of the conveyor are controlled by a zero pressure accumulation (ZPA) control algorithm. In its basic form, the ZPA control algorithm regulates the flow of product along a conveyor by monitoring a first zone and a second zone immediately downstream of the first zone. If the zone downstream of the first zone is empty, the product is allowed to be transported. If the zone downstream of the first zone is occupied, the product is not allowed to be transported. As described, the ZPA control algorithm creates a one zone length gap between the flow of products along the conveyor and prevents physical contact between the products flowing along the conveyor.

There are many various implementations of the ZPA control algorithm in industry. For example, the ZPA control algorithm may be implemented in hard pronged pneumatic logic and mechanical sensed rollers; discreet sensors and actuators wired to a localized logic block; combined logic and sensors with an actuator provided in each zone; combined logic and actuators with a sensor provided in each zone; or discrete sensors and actuators wired to a programmable logic controller that executes predetermined logic functions. It can be appreciated that each implementation of the ZPA control algorithm has advantages and disadvantages. For example, none of the present implementations of the ZPA control algorithm can be reconfigured to solve application issues that arise during and/or after installation of a conveyor system. As such, each implementation of the ZPA control algorithm requires the modification of the algorithm for a specific situation or location of product type. While a programmable logic controller (PLC) by its very nature can be reprogrammed, the cost to implement a conveyor with a ZPA control algorithm having discrete sensors and actuators, plus the extensive point-to-point wiring, is impractical. Further, localized implementations of the ZPA control algorithm having imbedded logic cannot be modified once installed. As a result, any variations to the standard ZPA control algorithm must be known at the time of manufacture/installation.

Therefore, it is a primary object and feature of the present invention to provide a method to customize a standard ZPA control algorithm for use in regulating the flow of products along a conveyor.

It is a further object and feature of the present invention to provide a method for customizing a standard ZPA control algorithm.

It is a further object and feature of the present invention to provide a method of customizing a standard ZPA control algorithm that may be simply and easily reconfigured to solve application issues that arise during or after installation of a conveyor system.

It is a still further object and feature of the present invention to provide a method of customizing a standard ZPA control algorithm that may be performed without modifying or adding firmware and without using an external control device such as a PLC or programmable relay and the associated external wiring.

It is a still further object and feature of the present invention to provide a method of customizing a standard ZPA control algorithm that is simple and inexpensive to implement.

In accordance with the present invention, a method is provided for controlling the transport of product along an accumulation conveyor. The accumulation conveyor has a plurality of zones. Each zone is independently driven and has a status corresponding to the presence of product thereon. The method includes the steps of generating a first data table containing instructions for transporting the product between a first pair of zones of the accumulation conveyor, and monitoring the status of the plurality of zones. A first zone is driven in response to the status of the plurality of zones in accordance with the instructions.

The first data table includes a first set of instructions for triggering a first predetermined event and a second set of instructions for validating the first predetermined event. In addition, the first data table includes a first data set generated in response to the monitored status of the plurality of zones. The first data set is compared against the first set of instructions and the first predetermined event is triggered in response to the first data set matching the first set of instructions.

A second data table may also be generated. The second data table contains instructions for transporting the product between a second pair of zones. More specifically, the second data table includes a first set of instructions for triggering a second predetermined event and a second set of instructions for validating the second predetermined event. The second data table may also include a first data set generated in response to the monitored status of the plurality of zones. The first data set of the second data table is compared against the first set of instructions of the second data table and the second predetermined event is triggered in response to the first data set of the second data table matching the first set of instructions of the second data table.

In accordance with a further aspect of the present invention, a method is provided of controlling the transport of product along an accumulation conveyor having a plurality of zones. Each zone of the accumulation conveyor is independently driven and has a status corresponding to the presence of product thereon. The method includes the steps of sensing the presence of product in the plurality of zones and generating corresponding product signals in response thereto. A first data table is generated in response to the product signals. The first data table includes a first set of instructions for triggering a first predetermined event and a first data set generated in response to the product signals. The first data set is compared against the first set of instructions and the first predetermined event is triggered in response to the first data set matching the first set of instructions.

The first predetermined event may include the step of driving a first zone to transport product thereon. However, other events are possible without deviating from the scope of the present invention. The first data table may also include a second set of instructions for qualifying the first predetermined event.

A second data table may also be generated in response to the product signals. The second data table includes a first set of instructions for triggering a second predetermined event and a first data set generated in response to the product signals. The second data table also includes a second set of instructions for qualifying the second predetermined event. The first data set of the second data table is compared against the first set of instructions of the second data table and the second predetermined event is triggered in response to the first data set of the second data table matching the first set of instructions of the second data table.

In accordance with a still further aspect of the present invention, a method is provided of controlling the transport of product along an accumulation conveyor having a plurality of zones. Each zone of the accumulation conveyer is independently driven. The method includes the steps of sensing the presence of product in the plurality of zones and generating corresponding product signals in response thereto. A first data set is derived from the product signals and a first set of instructions is generated for triggering a first predetermined event. The first data set is compared against the first set of instructions and the first predetermined event is triggered in response to the first data set matching the first set of instructions.

The first predetermined event may include the step of driving a first zone to transport product thereon. However, other events are possible without deviating from the scope of the present invention. The first data set and the first set of instructions partially define a first data table. The first data table also includes a second set of instructions for qualifying the first predetermined event.

A second data table may be generated in response to the product signals. The second data table includes a first set of instructions for triggering a second predetermined event and a first data set generated in response to the product signals. The second data table also includes a second set of instructions for qualifying the second predetermined event. The first data set of the second data table is compared against the first set of instructions of the second data table and the second predetermined event is triggered in response to the first data set of the second data table matching the first set of instructions of the second data table.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

Table 1 depicts an input register for the accumulation conveyer used in the methodology of the present invention;

Table 2 depicts a trigger register for the accumulation conveyer used in the methodology of the present invention;

Table 3 depicts a delay register for the accumulation conveyer used in the methodology of the present invention;

Table 4 depicts an output signal register for the accumulation conveyer used in the methodology of the present invention;

Table 5 depicts an output delay register for the accumulation conveyer used in the methodology of the present invention;

Table 6 depicts a signal conditioning register for the accumulation conveyer used in the methodology of the present invention;

Table 7 depicts a Zone Off Delay data table for use in the methodology of the present invention;

Table 8 depicts a Zone On Delay data table for use in the methodology of the present invention;

Table 9 depicts a first Loading Zone data table for use in the methodology of the present invention;

Table 10 depicts a second Loading Zone data table for use in the methodology of the present invention;

Table 11 depicts a Release Delay Timer data table for use in the methodology of the present invention;

Table 12 depicts a Accumulation Delay Timer data table for use in the methodology of the present invention;

FIG. 1 is a schematic view of an accumulation conveyer for use in the methodology of the present invention;

FIG. 2 is a schematic view of the controller for the accumulation conveyer of FIG. 1; and

FIG. 3 is flow chart of an algorithm for each data table in accordance with the present invention.

### DETAILED DESCRIPTION OF THE INVENTION

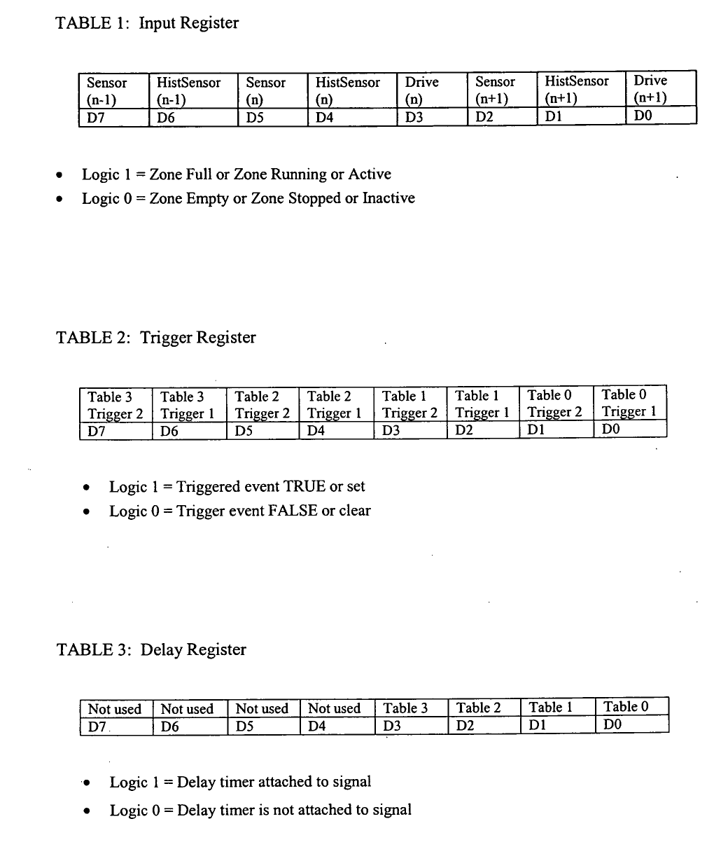

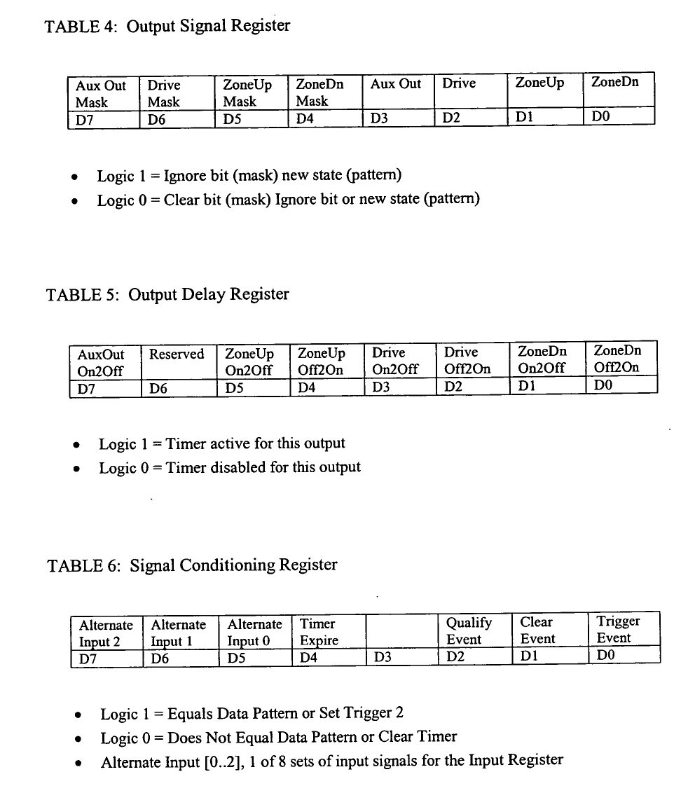

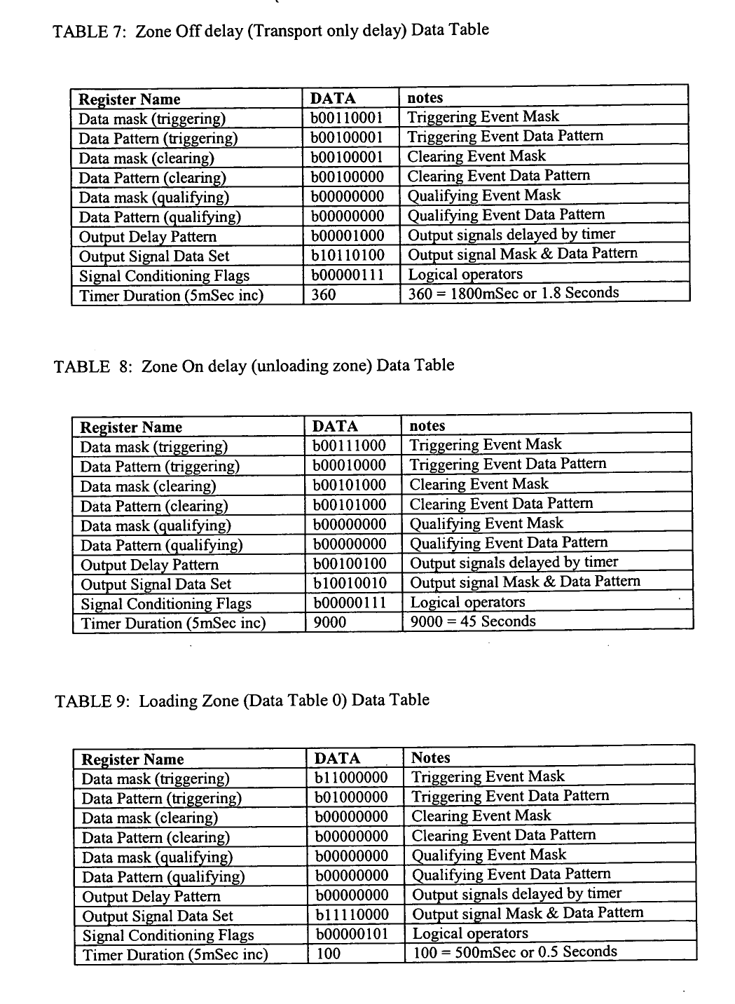

Referring to FIG. 1, a conveyor for performing the methodology of the present invention is generally designated by the reference numeral 10. In the preferred embodiment, conveyor 10 is an accumulation conveyor having an upper conveying surface defined by a plurality of zones. By way of example, conveyor 10 includes a central zone (n) having a first zone (n−1) upstream thereof and a second zone (n+1) downstream thereof. Additional zones may be provided upstream and/or downstream of central zone (n) without deviating from the scope of the present invention.

Conveyor 10 includes an upper conveying surface for transporting product between zones. By way example, the upper conveying surface of conveyor 12 may be defined by a plurality of rollers, belts, slats or the like. It is intended that the conveying surfaces of each zone (n−1, n and n+1) of conveyor 10 be driven independently by corresponding drive mechanisms 16a-16c, respectively. As hereinafter described, controller 18 receives data from various sensors 20a-20c monitoring the status of each zone (n−1, n and n+1) of conveyor 10 and generates corresponding outputs to the drive mechanisms 16a-16c of conveyor 10.

Operation of the zones (n−1, n and n+1) of conveyor 10 are controlled by the control algorithm of the present invention. It can be appreciated that a conveyor algorithm can be defined by the equation:
Output=[Data Table(i)+Inputs(i)+Timers(i)] Equation (1)
wherein the i is the number of data tables in a particular zone of conveyor 10 and the output corresponds to the signals generated by controller 18 to actuate drive mechanisms 16a-16c. It cam be appreciated that controller 18 may comprise a single controller operatively connected to each zone through bus 19 or a plurality of controller units located at corresponding zones (n−1, n and n+1) and communicating with each other on bus 19. The control algorithm of the present invention evaluates a predetermined number of inputs and generates a predetermined number of outputs in response thereto according to various data tables (hereinafter described) defined by a user. It can be appreciated that there are intermediate states generated prior to generation of the outputs as part of the control algorithm. Examination of these signals (the inputs and the intermediate states), or a sub-set of them, provides a snap shot in time of the current state of the control algorithm. By this method, specific conditions or states can be recognized and used as triggering events, hereinafter described. The outputs generated from the control algorithm are then used to control the drive mechanisms 16a-16c, as well as, provide inputs to other internal or external control logic. These outputs signals can be selectively delayed under specified conditions resulting in a modification to the standard control algorithm.

As hereinafter described, the control algorithm of the present invention utilizes user defined data sets to modify operation of conveyor 10 to meet application specific requirements. Each time the control algorithm is run, typically at some periodic interval, operation of conveyor 10 is modified by the specific conditions or states thereof. The number of user defined data sets is limited only by memory and execution time. Multiple user defined data sets allows for specific events or sequence of events to be captured and used as triggering events. The data tables identified in Equation (1) provide a means to define the variables and constants and, in turn, define the outputs.

As heretofore described, the outputs of sensors 20a-20c are provided as inputs to corresponding common input registers for entry into predetermined data tables. The entries in each data table are evaluated against a common set of registers, hereinafter described. The common input registers define the current state of conveyor 10, as viewed by a predetermined current zone (e.g., n) of conveyor 10. Further, the common input registers are monitored for defined triggering events and clearing events, hereinafter described. This allows isolated data tables to be “chained” together to build more complex algorithms. For each output signal, there is a common delay register, used to “attach” an output signal to a delay timer. This allows isolated data tables to logically OR the control of output signals together.

Input Register

Each input register 22 of controller 18 monitors the inputs received from sensors 20a-20c in a three zone window, namely, zones (n−1, n, and n+1) in the depicted embodiment, over predetermined periodic intervals. Referring to Table 1, input register 22 for central zone (n) receives the inputs provided by sensors 20a-20c at predetermined bits D7, D5 and D3, respectively, at periodic intervals. In addition, bits D6, D4 and D2 are updated at predetermined periodic intervals to the prior state (HistSensor) of the inputs provided by sensors 20a-20c to bits D7, D5 and D3, respectively. Bits D3 and D0 of input register 22 are provided with the state of drive mechanisms 16b and 16c of zones (n) and (n+1). Input register 22 is common to all data tables and is updated at the periodic predetermined intervals prior to the execution of the logic functions, hereinafter described.

Trigger Register

Referring to Table 2, trigger register 24 reflects the current state of triggering events for each of the data tables. Trigger register 24 is common to all data tables and is updated as each data table is evaluated by the control algorithm. Triggering events are used to indicate the current status of any event defined by a data table. Trigger register 24 is further evaluated by the control algorithm for a qualifying event, as defined by the data tables. This is the mechanism by which events or algorithms can be combined to build sequential logic. This common register allows each data table to “see” the logical state of any other data table.

Delay Register

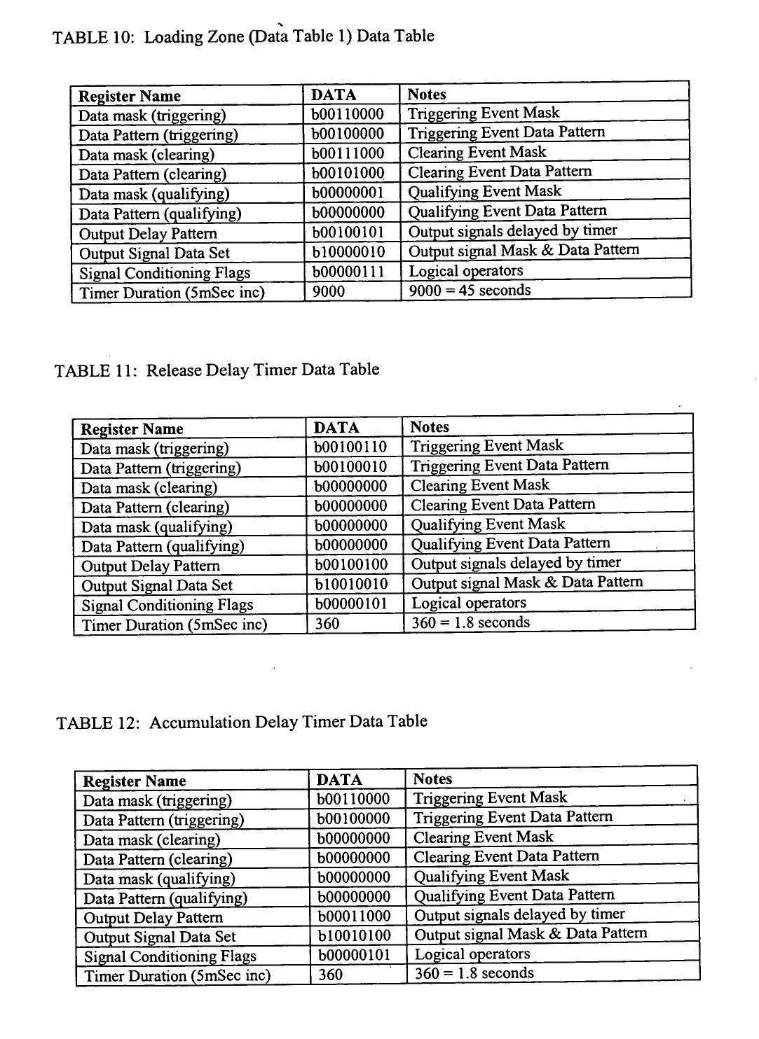

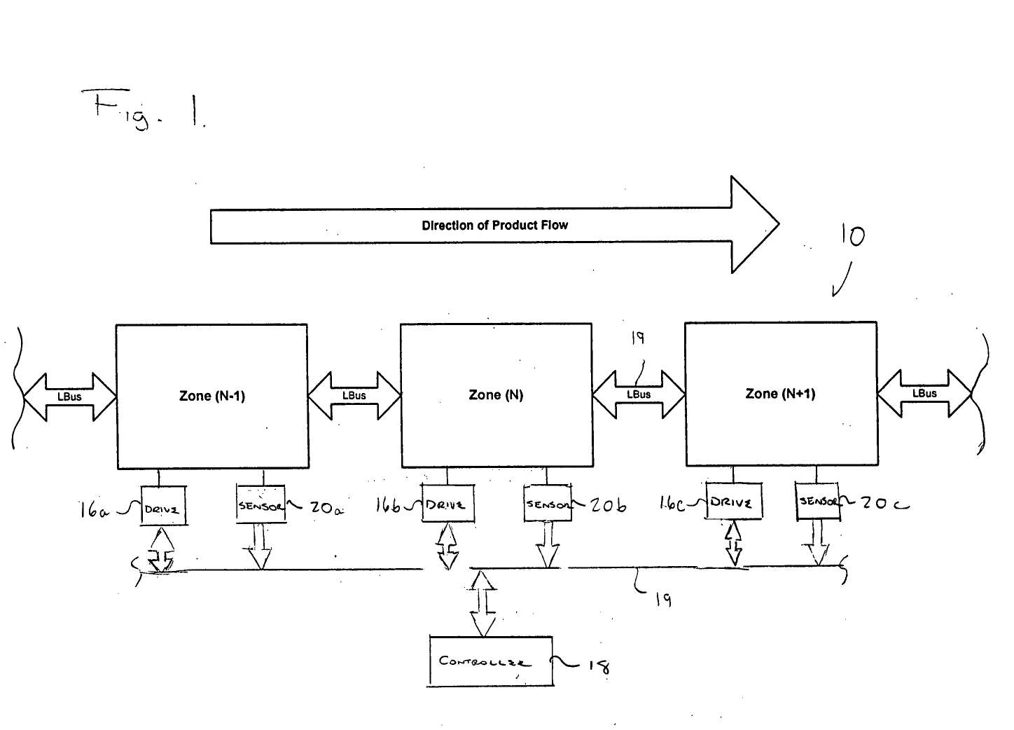

Referring to Table 3, delay register 26 is depicted. For each output signal that can be controlled through the data tables, delay register 26 is used to “attach” a time delay to changes in the output. Data tables 28a-28d, FIG. 2, control corresponding bits D0-D3 in delay register 26. To attach a time delay to an individual signal, a predetermined bit D0-D3 is set in that delay register 26. Upon a time out of the timer or a clearing event, the predetermined bit D0-D3 is then cleared. Output signals are then delayed if any timer has a predetermined bit D0-D3 set in the delay register. There is one delay register 26 for each transitional direction of each output signal controlled, an on-to-off transition and off-to-on transition. In the present example, four outputs are provided so there are eight delay registers in total.

The data tables utilize predetermined data sets to continuously update the control algorithm. More specifically, each data table contains various data sets that define a triggering event, a qualifying event, a clearing event, a delay interval and output signal conditioning definitions. Input register 22 is monitored for triggering and clearing events and trigger register 24 is monitored for qualifying events. Each data set consists of three parts, a data mask, a data pattern and a signal conditioning flag. The data mask is used to identify the input signals in input register 22 that are of interest and to force the remaining input signals in input register 22 to a fixed state. The data pattern is the pattern or signal state that defines the triggering event which, in turn, is used initiate or arm associated logic. The signal conditioning flag defines whether the data pattern is “TRUE” for a match or not match condition.

As heretofore described, a triggering event is used to initiate or arm the associated logic. Input register 22 is evaluated by the control algorithm using the data set defined for the triggering event. The result must evaluate to “TRUE” in order to satisfy the logic requirements. A qualifying event is used to qualify or validate the triggering event logic. Trigger register 24 is evaluated by the control algorithm using the data set defined for the qualifying event. The result must evaluate to “TRUE” to satisfy the logic requirement. Finally, a clearing event is used to clear or reset the current timer logic. Input register 24 is also evaluated using the data set defined for the clearing event. The result must evaluate to “TRUE” in order to satisfy the logic requirement.

Output Signal Register

Referring to Table 4, the definitions of the output signals that can be set are provided. The output signal register holds both halves of a data set, a data mask and data pattern used to drive or leave alone the output signals. The data mask (upper 4 bits) allows the ignore bits to be preserved and clears the bits of interest. The data pattern bits (lower 4 bits) are OR'd in with the ignore bits to force new states. The ZoneUp and ZoneDn signals are the sensor signals communicated upstream and downstream from the current zone (n) of conveyor 10

Output Delay Register

Table 5 defines the output signal transitions that are attached to the delay timer associated with the data table. Each signal that is attached is inhibited from changing states for duration of the delay timer. Any, all or none of the signals can be attached to the delay timer. A single delay timer can control multiple output signals. If no signals are attached, the timer becomes a generic timer with its expiration generating a second triggering event. It can be appreciated that the output delay register is useful in qualifying sequential logic sequences.

Timer Duration Register

The timer duration register defines an amount of time that is loaded into a down counting timer register. Data tables 28a-28d has a corresponding time delay register or timer, 39, 41, 43 and 45, respectively, FIG. 2, associated with it. When a triggering event is followed by a qualifying event, the timer is loaded with the preset value from the data table. The timer is decremented at a periodic interval and is considered expired when it has a value of 0. A signal conditioning flag is associated with the expiration of the timer. At expiration of the timer, one of two actions are possible, either the data table registers are reset (just like a clearing event) or set a second triggering flag is set for use by other data table qualifying events.

Signal Conditioning Register

Referring to Table 6, the signal conditioning register holds flags used to modify or condition the signals evaluated by the control algorithm. These include the polarity of event signals, action upon expiration of timer and pattern used to define the input register.

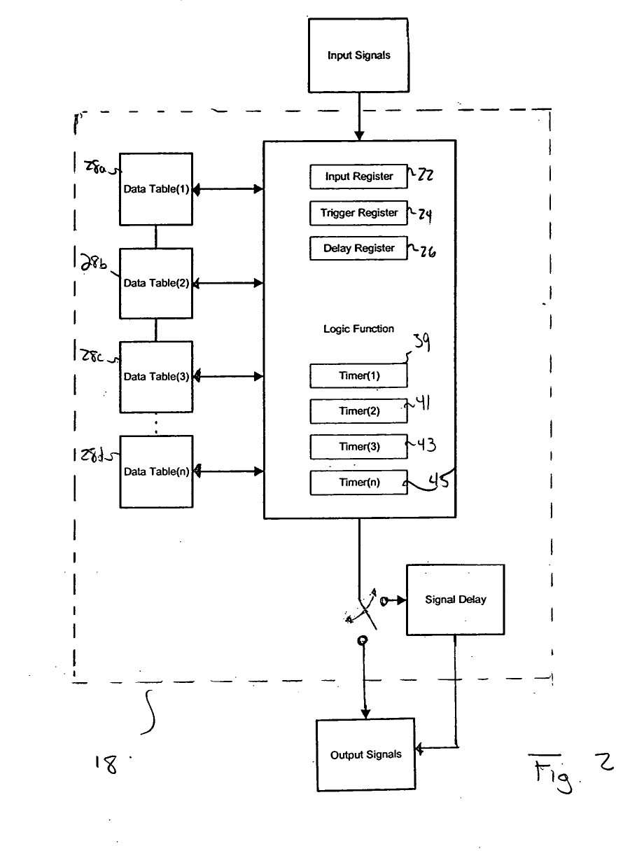

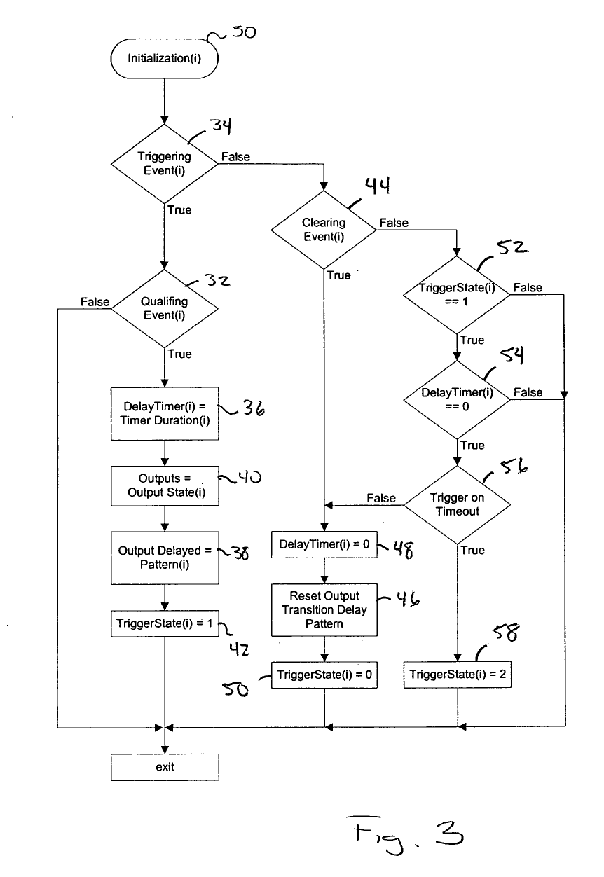

In order to facilitate understanding of the methodology of the present invention and operation of the accumulation conveyor, a plurality of examples are hereinafter provided. Referring to FIG. 1-3, in operation, controller 18 of conveyer 10 receives inputs, block 22, for sensors 20a-20c and the inputs are provided to input register 22, trigger register 24, and delay register 26. Controller 18 reviews input register 22, trigger register 24, and delay register 26 and generates data masks for the triggering event, the clearing event and the qualifying event. Thereafter, controller 18 sequentially evaluates each data table 28a-28d utilizing a common algorithm, FIG. 3, at predetermined periodic intervals. Tables 7-12 depict various data tables that may be evaluated during operation of a three zone conveyor as heretofore described. It can be appreciated that additional zones may be added to conveyor 10, as well as, additional data tables may be provided to controller 18 without deviating from the scope of the present invention.

Referring to Table 7, a Zone Off Delay (transport only delay) data table is provided. As is conventional, the control algorithm of the present invention stops drive mechanism 16b when both sensors 20b and 20c detect product. The Zone Off Delay modifies the control algorithm by delaying the stopping of drive mechanism 16b when product is detected by both sensors 20b and 20c for a predetermined time period, e.g., 1800 mSec, unless drive mechanism 16c is also stopped. This process may be useful when conveying mixed size product to facilitate “filling” of conveyor 10. It is also useful on higher speed conveyors where repeated momentary stopping of the drive mechanism can cause cavitations in the conveying surface. Controller 18 provides the data pattern for the triggering event, the clearing event and the qualifying event. More specifically, the triggering event is initialized, block 30, to monitor the transitions in the current zone (n) and the state of the drive mechanism 16c in the zone downstream (n+1). The signal conditioning flag is set for “Equal to Data Pattern” and the pattern is set for the current zone (n) to transition from un-blocked to blocked with the zone downstream (n+1) driving. The qualifying event is disabled in that it will always evaluate to a TRUE, block 32

When the current zone (n) transitions from un-blocked to blocked and the zone downstream (n+1) is running, the triggering event has been satisfied, block 34. This loads timer 39 with a value of 360, setting the delay duration to 1800 milliseconds (360 * 5 milliseconds), block 36. Controller 18 loads the output delay pattern attaching the drive on to off signal to timer 39, block 38. The Output Signal Data set forces the drive signal to Run, block 40. Additionally, the Trigger 1 flag is set TRUE in the trigger register 24, indicating that the triggering event has been armed, block 42. Timer 39 is allowed to run until it expires or is cleared.

The clearing event is initialized to monitor the state of sensor 20b in current zone (n) and the state of drive mechanism 16c in the zone downstream (n+1), block 44. The signal conditioning flag is set for “Equal to Data Pattern” and the pattern is set for the current zone (n) to be blocked with the zone downstream (n+1) to be stopped.

When the current zone (n) is blocked and the zone downstream (n+1) is stopped, the clearing event has been satisfied. This, in turn, clears the timer and output delay register, block 46, and removes the delay on the Drive On to Off signal, block 48, allowing drive mechanism 16b to be stopped immediately. Thereafter, the Trigger 1 and 2 flags are cleared in trigger register 24, block 50.

While the Trigger 1 flag is TRUE, block 52, timer 39 is monitored for expiration, block 54. Should timer 39 expire prior to the clearing event being satisfied, timer expiration flag D4 in the signal conditioning register, Table 6, is checked, block 56. If the timer expiration flag is set, the Trigger 2 flag is then set, block 58. In Table 7, the Timer Expire flag is cleared, indicating the control algorithm should clear Trigger 1 and Trigger 2 flags in trigger register 24 and clear the Output Delay Register, thus completing the reset of the logic. Expiration of timer 39 satisfies the delay on the Drive On to Off signal, allowing drive mechanism 16b to be stopped immediately as part of the control algorithm.

Referring to Table 8, a Zone On Delay (unloading zone) data table is provided. In the control algorithm of the present invention, no provision is provided for detecting how product leaves a given zone. An unloading zone is an application wherein product can be removed from the conveying surface from the side, such as removing a pallet using a fork lift, as well as, being transported to the zone downstream (n+1). The Zone Off Delay modifies the control algorithm by detecting when product leaves a given zone by a means other than normal transport to the zone downstream. The Zone On Delay then modifies and delays signals to drive mechanism 16a and the zone upstream (n−1). Controller 18 provides the data pattern for the triggering event, the clearing event and the qualifying event. The triggering event is set to monitor transitions and the state of drive mechanism 16b in the current zone (n). The signal conditioning flag is set for “Equal to Data Pattern” and the data pattern is set for transition from blocked to unblocked with drive mechanism 16b stopped in the current zone (n). The qualifying event is disabled in that it will always evaluate to a TRUE.

When the current zone (n) transitions from blocked to un-blocked and drive mechanism 16b is stopped in the current zone (n), the triggering event has been satisfied. This is detection of product removal from a zone other than being driven downstream. Timer 39 is loaded with a user selected value (e.g., 9000) thereby setting the delay to a predetermined duration (e.g., 45 seconds). In addition, the Output Delay Pattern is loaded thereby attaching the Drive Off to On signal and the Zone Up On to Off signal to timer 39. The Output Signal Data set forces the drive signal to Stopped and the Zone Up signal to Blocked. Additionally the Trigger 1 flag is set TRUE in trigger register 24, indicating that the triggering event has been armed. Timer 39 is allowed to run until it expires or is cleared.

The clearing event is initialized to monitor state of sensor 20b and drive mechanism 16b in the current zone (n). The signal conditioning flag is set for “Equal to Data Pattern” and the data pattern is set for sensor 20b to be blocked with drive mechanism 16b running in the current zone (n). When the current zone (n) is blocked and drive mechanism 16b in the current zone (n) is driving, the clearing event has been satisfied. This, in turn, clears the timer and the Output Delay Register. In addition, the delay is removed on the Drive Off to On signal and the Zone Up On to Off signal, allowing drive mechanism 16b and zone up signals to be updated immediately as part of the control algorithm. The Trigger 1 and 2 flags are cleared in the trigger register 24.

Should the timer expire prior to the clearing event being satisfied, the delay on the Drive Off to On and Zone Up On to Off signals has been satisfied, allowing both to be updated immediately as part of the control algorithm. The Timer Expire flag is cleared, indicating the control algorithm should clear Trigger 1 and Trigger 2 flags in trigger register 24 and clear the Output Delay Register, thus completing the reset of the logic.

To realize a Loading Zone application, two data tables must be chained together, Tables 9 and 10. It is contemplated for the control algorithm th have no provision for detecting how product enters a given zone. A loading zone is an application where product can be placed on the conveying surface from the side, such as placing a pallet using a fork lift, as well as, being transported from the zone up stream (n−1). It is contemplated to modify the control algorithm only when product enters a given zone by a means other than normal transport from the zone up stream (n−1). The control algorithm then modifies and delays signals to drive mechanisms 16a and 16c in the zone upstream and zone downstream, respectively. Table 9 is used is used as an event timer to qualify the triggering of the second event, when it is active. Once again, controller 18 provides the data pattern for the triggering event, the clearing event and the qualifying event. The triggering event is set to monitor transitions in the upstream zone (n−1). The signal conditioning flag is set for “Equal to Data Pattern” and the data pattern is set for transition from blocked to un-blocked in the upstream zone (n−1). The qualifying event is disabled in that it will always evaluate to a TRUE.

When the upstream zone (n−1) transitions from blocked to un-blocked, the triggering event has been satisfied. The trailing edge of product as it exits the zone upstream (n−1) marks the start of the travel time. The leading edge of product as it is detected in the current zone (n) marks the end of travel time. This, in turn, loads timer 39 with a value of 100 setting the timer duration to 500 mSec. The Output Delay Pattern has a value of 0 and does not attach any signals to timer 39. The Output Signal Data set does not affect any outputs. Additionally the Table 9 [Data Table 0] Trigger 1 flag is set TRUE in trigger register 24, indicating that the triggering event has been armed. Timer 39 is allowed to run until it expires or is cleared.

The clearing event is initialized to ignore all inputs. The signal conditioning flag is set for “Not Equal to Data Pattern” and the data pattern is set equal to the result for ignore all or 0. This disables the clearing event, thereby requiring timer 39 to expire once it has been armed in order to generate a clearing event.

Once timer 39 has been loaded, it will run until expiration. The Output Delay Pattern is equal to 0, so no outputs are tied timer 39. The Timer Expire flag is cleared, indicating the logic should clear Trigger 1 and Trigger 2 flags in trigger register 24, thus completing the reset of the timer logic. Timer 39 is configured to function as a travel timer. The trailing edge of product as it exits the zone upstream (n−1) marks the start of the travel time. The leading edge of product as it is detected in the current zone (n) marks the end of travel time. If it is running, then product must be traveling from the zone upstream (n−1) into the current zone (n). If it is not running, then product entered the current zone (n) by means other than being driven in from the upstream zone, i.e., the product may be deposited directly on current zone (n).

Referring to the Loading Zone (Data Table 1) Data Table, Table 10, the triggering event is set to monitor transitions in the current zone (n). The signal conditioning flag is set for “Equal to Data Pattern” and the data pattern is set for transition from un-blocked to blocked in the current zone (n). The qualifying event is enabled to monitor the state of Trigger 1 of the Loading Zone (Data Table 0) Data Table, Table 9. The signal conditioning flag is set for “Equal to Data Pattern” and the data pattern is set for Trigger 1 to be FALSE.

When the current zone (n) transitions from un-blocked to blocked the triggering event has been satisfied. The qualifying event is satisfied when the Trigger 1 flag of Loading Zone (Data Table 0) Data Table, Table 9, is FALSE. This occurs when product enters the current zone (n) while the Travel Timer=0. This is designed to trap product entry into the current zone (n) that is not driven in from the zone upstream (n−1). Timer 41 is loaded with a value of 9000 setting the timer duration to 45 seconds. The Output Delay Pattern is loaded attaching the Zone Up On to Off and Drive Off to On signals to this timer. The Output Signal Data set forces the drive signal to Stopped and the Zone Up signal to Blocked. The Trigger 1 flag is set TRUE in the Trigger Register, indicating that the Triggering Event has been armed. Timer 41 is allowed to run until it expires or is cleared.

The clearing event is initialized to monitor the state of sensor 20b and the state of drive mechanism 16b in the current zone (n). The signal conditioning flag is set for “Equal to Data Pattern” and the pattern is set for the current zone (n) to be blocked and driving. When the current zone (n) is blocked and drive mechanism 16b in the current zone (n) is driving, the clearing event has been satisfied. This clears the timer and the Output Delay Register, and removes the delay on the Drive Off to On signal and the Zone Up On to Off signal, allowing drive mechanism and zone up signals to be updated immediately. The Trigger 1 and 2 flags are cleared in the trigger register 24. In the event that the timer expires prior to the clearing event being satisfied, the delay on the Drive Off to On and Zone Up On to Off signals has been satisfied, allowing both to be updated immediately as part of the control algorithm. The Timer Expire flag is cleared, indicating the logic should clear Trigger 1 and Trigger 2 flags in trigger register 26 and clear the Output Delay Register, thus completing the reset of the logic.

A common use of accumulation conveyor 10 is to collect or accumulate product for controlled release into another process. When product has accumulated on conveyor 10, there is product in each successive zone starting the most downstream zone continuing upstream. Product is commonly released once accumulated in this manor, in one of two mode, singulated release or slug release. In singulated release, a one zone gap is pulled between product as it is released. Slug release is where all zones occupied drive at once and product is transported off conveyor 10 in a train like manor. Slug and singulated release are commonly selected using an external signal, typically from a PLC, driven by the overall facilities control software. A release delay application is to pull a partial zone gap between product as it is released and is most commonly used in conjunction with slug release operations.

Referring to the Release Delay Timer Data Table, Table 11, the triggering event is set to monitor transitions in the downstream zone (n−1). The signal conditioning flag is set for “Equal to Data Pattern” and the data pattern is set for transition from blocked to un-blocked in the downstream zone (n+1). The qualifying event is disabled in that it will always evaluate to a TRUE.

The clearing event is initialized to ignore all inputs. The signal conditioning flag is set for “Not Equal to Data Pattern” and the data pattern is set equal to the result for ignore all or 0. This disables the clearing event thereby requiring the timer to expire once it has been armed in order to generate a clearing event. When the downstream zone (n+1) transitions from a blocked to un-blocked state, the triggering event has been satisfied. This, in turn, loads the timer 39 with 1.8 seconds of delay. The Drive and ZoneUp signals are forced to stopped and Blocked. The timer is attached to the Drive off-to-on signal and ZoneUp on-to-off signal. As a result, actuation of drive mechanism 16b and the not blocked signal being relayed is delayed for 1.8 seconds in the case of an active slug signal.

The control algorithm will stop drive mechanism 16b when both sensors 20b and 20c detect product. The Accumulation Delay modifies the control algorithm by delaying the stopping of drive mechanism 16b when product is detected by both sensors 20bB and 20c for a predetermined time period, e.g., 1800 mSec. This is identical to the Zone Off Delay with the exception it does not monitor the drive mechanism 16c. This is useful when conveying mixed size product to facilitate “filling” of conveyor 10.

Referring to the Accumulation Delay Timer Data Table, Table 12, the triggering event is set to monitor transitions of sensor 20b in the current zone (n). The signal conditioning flag is set for “Equal to Data Pattern” and the data pattern is set for transition from un-blocked to blocked in the current zone (n). The qualifying event is disabled in that it will always evaluate to a TRUE. The clearing event is initialized to ignore all inputs. The signal conditioning flag is set for “Not Equal to Data Pattern” and the data pattern is set equal to the result for ignore all or 0. This, in turn, effectively disables the clearing event, requiring the timer 39 to expire once it has been armed, to generate a clearing event.

When sensor 20b transitions from un-blocked to blocked state, the triggering event has been satisfied such that the timer 39 is loaded with 1.8 seconds of delay. The drive signal is forced to run and the ZoneUp signal is forced to un-blocked. The timer is attached to the Drive on-to-off signal and the ZoneUp off-to-on signal. This, in turn, delays drive mechanism 16b turning off and sending a blocked signal up stream for 1.8 seconds.

As described, the present invention provides a method to customize a control algorithm for conveyor 10. The advantage over previous methods is no new firmware is required and no discrete wiring back to a central PLC is required. The control algorithm is defined by way of a data table and then uploaded into a controller. The data table is evaluated in conjunction with system inputs that feed the control algorithm and generates outputs that can directly customize the control algorithm. Multiple data tables can be loaded into the controller. These data table can be independent or combined with others to construct the algorithm. This provides a significant advantage in that the algorithm can solve problems yet to identified.

Various modes of carrying out the invention are contemplated as being within the scope of the following claims particularly pointing out and distinctly claiming the subject matter that is regarded as the invention.

I claim:

1. A method of controlling the transport of product along an accumulation conveyor having a plurality of zones, each zone being independently driven and having a status corresponding to the presence of product thereon, comprising the steps of:
generating a first data table containing instructions for transporting the product between a first pair of zones of the accumulation conveyor;
monitoring the status of the plurality of zones; and
driving a first zone in response to the status of the plurality zones in accordance with the instructions.

2. The method of claim 1 wherein the data table includes a first set of instructions for triggering a first predetermined event.

3. The method of claim 2 wherein the first data table includes a second set of instructions for validating the first predetermined event.

4. The method of claim 3 wherein the first data table includes a first data set generated in response to the monitored status of the plurality of zones.

5. The method of claim 4 further comprising the additional steps of comparing the first data set against the first set of instructions and triggering the first predetermined event in response to the first data set matching the first set of instructions.

6. The method of claim 5 further comprising the additional step of generating a second data table containing instructions for transporting the product between a second pair of zones.

7. The method of claim 6 wherein the second data table includes a first set of instructions for triggering a second predetermined event.

8. The method of claim 7 wherein the second data table includes a second set of instructions for validating the second predetermined event.

9. The method of claim 8 wherein the second data table includes a first data set generated in response to the monitored status of the plurality of zones.

10. The method of claim 9 further comprising the additional steps of comparing the first data set of the second data table against the first set of instructions of the second data table and triggering the second predetermined event in response to the first data set of the second data table matching the first set of instructions of the second data table.

11. The method of claim 2 wherein the first predetermined event is the driving of the first zone.

12. A method of controlling the transport of product along an accumulation conveyor having a plurality of zones, each zone being independently driven and having a status corresponding to the presence of product thereon, comprising the steps of:
sensing the presence of product in the plurality of zones and generating corresponding product signals in response thereto;
generating a first data table in response to the product signals, the first data table including:
a first set of instructions for triggering a first predetermined event; and
a first data set generated in response to the product signals; and
comparing the first data set against the first set of instructions and triggering the first predetermined event in response to the first data set matching the first set of instructions.

13. The method of claim 12 wherein the first predetermined event includes driving a first zone to transport product thereon.

14. The method of claim 13 wherein the first data table includes a second set of instructions for qualifying the first predetermined event.

15. The method of claim 12 further comprising the additional step of generating a second data table in response to the product signals, the second data table including:
a first set of instructions for triggering a second predetermined event; and
a first data set generated in response to the product signals.

16. The method of claim 15 wherein the second data table includes a second set of instructions for qualifying the second predetermined event.

17. The method of claim 9 further comprising the additional steps of comparing the first data set of the second data table against the first set of instructions of the second data table and triggering the second predetermined event in response to the first data set of the second data table matching the first set of instructions of the second data table.

18. The method of claim 12 comprising the additional step of delaying the first predetermined event for a user defined time period after the triggering step.

19. A method of controlling the transport of product along an accumulation conveyor having a plurality of zones, each zone being independently driven, comprising the steps of:
sensing the presence of product in the plurality of zones and generating corresponding product signals in response thereto;
deriving a first data set from the product signals;
generating a first set of instructions for triggering a first predetermined event; and
comparing the first data set against the first set of instructions and triggering the first predetermined event in response to the first data set matching the first set of instructions.

20. The method of claim 19 wherein the first predetermined event includes driving a first zone to transport product thereon.

21. The method of claim 19 wherein the first data set and the first set of instructions partially define a first data table.

22. The method of claim 21 wherein the first data table includes a second set of instructions for qualifying the first predetermined event.

23. The method of claim 21 further comprising the additional step of generating a second data table in response to the product signals, the second data table including:
a first set of instructions for triggering a second predetermined event; and
a first data set generated in response to the product signals.

24. The method of claim 23 wherein the second data table includes a second set of instructions for qualifying the second predetermined event.

25. The method of claim 24 further comprising the additional steps of comparing the first data set of the second data table against the first set of instructions of the second data table and triggering the second predetermined event in response to the first data set of the second data table matching the first set of instructions of the second data table.

26. The method of claim 19 comprising the additional step of delaying the first predetermined event for a user defined time period after the triggering step.
